(19) United States
(12) Patent Application Publication
(10) Pub. No.: US 2023/0287897 A1
(43) Pub. Date: Sep. 14, 2023

(54) CEILING FAN WITH ADJUSTABLE BLADES

(71) Applicant: CORDELIA LIGHTING, INC., RANCHO DOMINGUEZ, CA (US)

(72) Inventors: AARON O'BRIEN, SUMMERVILLE, SC (US); JAMES KENG, RANCHO DOMINGUEZ, CA (US)

(73) Assignee: CORDELIA LIGHTING, INC., RANCHO DOMINGUEZ, CA (US)

(21) Appl. No.: 17/976,846

(22) Filed: Oct. 30, 2022

Related U.S. Application Data
(60) Provisional application No. 63/317,963, filed on Mar. 9, 2022.
(60) Provisional application No. 63/321,657, filed on Mar. 18, 2022.

(51) Int. Cl. F04D 29/36; F04D 25/06; F04D 29/32; F21V 33/00

(52) U.S. Cl. CPC F04D 29/36; F04D 25/06; F04D 29/325; F21V 33/0096

(57) ABSTRACT

An electric ceiling fan and ceiling fan kit having adjustable fan blades. The fan and kit include blade irons each with an arm having various mounting holes drilled at different distances from the hub. When the fan blades are attached to specific holes on the blade iron, the sweep of the fan blades is adjusted and set. Different length fan blades and/or blade irons may be used to adjust the fan blade sweep diameter. The blade iron may be constructed from sections that are stackable or removable, again to adjust its length by the installer and thus increasing or decreasing the fan blade sweep diameter. The blade iron may telescope to set its length, and the twist lock threads also allow for setting a blade pitch angle. The blade iron may twisted along its length to deform its shape or be inserted at an angle into the motor hub to set the blade pitch angle.

### CROSS-REFERENCE TO RELATED APPLICATIONS

This application claims priority from provisional application No. 63/317,963, filed Mar. 9, 2022, and from provisional application No. 63/321,657, filed Mar. 18, 2022, the contents of all of which are hereby incorporated by reference.

### FIELD OF THE INVENTION

The present invention relates to electric ceiling fans. More precisely, the present invention relates to an electric ceiling fan and kit having user adjustable fan blades for sweep and pitch.

### BACKGROUND

A conventional construction of an electrical ceiling fan has an electric motor mounted at the center axis of the fan with blades that extend radially outward from the center. The conventional ceiling fan is mounted to an electrical junction box attached to a ceiling joist. The junction box includes a mounting bracket that receives a canopy and a down rod therein. The down rod passes through the canopy and into the motor housing containing the electric motor. A plurality of mounting arm brackets are attached to the motor's rotating center shaft as with spokes on a hub of a wagon wheel. Each mounting arm bracket has permanently affixed to it a radially extending fan blade. Just beneath the rotating blades is an optional light fixture enclosing an illumination source such as a bulb or LED. The hot-neutral-ground connections inside the junction box consist of the wiring fed through the hollow core of the down rod to power the electric motor. The junction box is wired to a common AC power source.

Conventional ceiling fans are sold with a fixed fan blade outside diameter or sweep, and their blades are permanently attached to the mounting arm bracket. The consumer typically purchases the fan size, blade sweep, and volume of air movement desired based on the requirements of his or her room size. As a result, retailers must maintain a large variety of fan sizes with varying fan blade sweeps in inventory to cater to the varying demands of the consumer. This is not efficient use of a retailer's shelf space or its capital investment in potentially unsold inventory of unpopular fan sizes.

### SUMMARY OF THE INVENTION

The present invention in a preferred embodiment is directed to an electric ceiling fan and kit that includes a user- or installer-adjustable fan blade sweep diameter, and optionally, a fan blade pitch adjustment. Thus, one fan kit can accommodate many consumers' varied demands for a fan sweep personalized to their own unique room size and preferred air movement volume (CFM or Cubic Feet per Minute) for that room size.

The preferred embodiment fan and kit include a down rod passing through a canopy, a motor that is disposed proximate the canopy and engages the down rod, wherein the motor includes a hub. A plurality of fan blades each having a fixed, non-telescoping length with a flat profile and includes a proximal end and a distal end. The fan has a plurality of blade irons each having a first end and second end, wherein the blade iron is attached to the motor hub at the first proximal end, and the second distal end includes an arm engaging the proximal end of the blade that can be manually adjusted for the blade's desired sweep an/or pitch.

The blade iron arm includes any one or combination of the following features: (a) an arm length with different attachment points along the length connected to the proximal end of the blade; (b) a telescoping length connected to the proximal end of the blade; (c) at least two discrete segments joined to each other with different attachment points connected to the proximal end of the blade; (d) arms of different lengths each connectable to the proximal end of the blade; (e) jaws that clamp the proximal end of the blade; and (f) discrete segments stackable together and connected to the proximal end of the blade; and (g) angular attachment points connected to the proximal end of the blade to set a pitch of thereof. The fan kit may be further supplied with different length blades so the end user or installer can select the desired blade length and manually attach each to the respective blade iron arm. The fan has a power supply conducting electricity to the motor. Optionally, the fan may include a light fixture with, e.g., LEDs, to also operate as an illumination source.

### BRIEF DESCRIPTION OF THE DRAWINGS

FIG. 1 is a perspective view of a preferred embodiment ceiling fan with the blades set at an extended radial length for maximum sweep.

FIG. 2 is another perspective view of the ceiling fan of FIG. 1.

FIG. 3 is another perspective view of the ceiling fan of FIG. 1.

FIG. 4 is another perspective view of the ceiling fan of FIG. 1.

FIG. 5 is another perspective view of the ceiling fan of FIG. 1.

FIG. 6 is a perspective view of the ceiling fan from FIG. 1 with the blades set at a short radial length for minimum sweep.

FIG. 7 is another perspective view of the ceiling fan of FIG. 6.

FIG. 8 is another perspective view of the ceiling fan of FIG. 6.

FIG. 9 is another perspective view of the ceiling fan of FIG. 6.

FIG. 10 is an illustration of the major components of an electric ceiling fan.

FIG. 11 is a schematic depicting the blade sweep of a ceiling fan.

FIG. 12 shows an exemplary embodiment ceiling fan blade.

FIG. 13 shows the reverse side of the ceiling fan blade of FIG. 12.

FIG. 14 shows an exemplary embodiment blade iron.

FIG. 15 shows the reverse side of the blade iron of FIG. 14.

FIG. 16 shows a preferred embodiment down rod.

FIG. 17 shows miscellaneous components and fasteners that assemble to the blade irons.

FIG. 18 is an electric motor.

FIG. 19 is a cover disposed on top of the motor.

FIG. 20 is a lens cover for the light fixture.

FIG. 21 is a light fixture located at the bottom of the ceiling fan.

FIG. 22 shows a preferred embodiment electric ceiling fan kit.

FIG. 23A shows a set of long fan blades and FIG. 23B shows a set of short fan blades, both sets optionally supplied in the kit.

FIG. 24 shows an alternative embodiment blade iron that can be separated into sections.

FIG. 25 shows a preferred embodiment blade iron with a blade pitch adjustment.

FIG. 26 shows an alternative embodiment blade iron.

FIG. 27 shows another alternative embodiment blade iron.

FIG. 28 shows yet another alternative embodiment blade iron.

FIG. 29 shows a motor hub with pitch adjustable collars to receive blade irons.

FIG. 30 shows an alternative embodiment blade iron that is threaded and stackable.

### DETAILED DESCRIPTION OF THE PREFERRED EMBODIMENTS

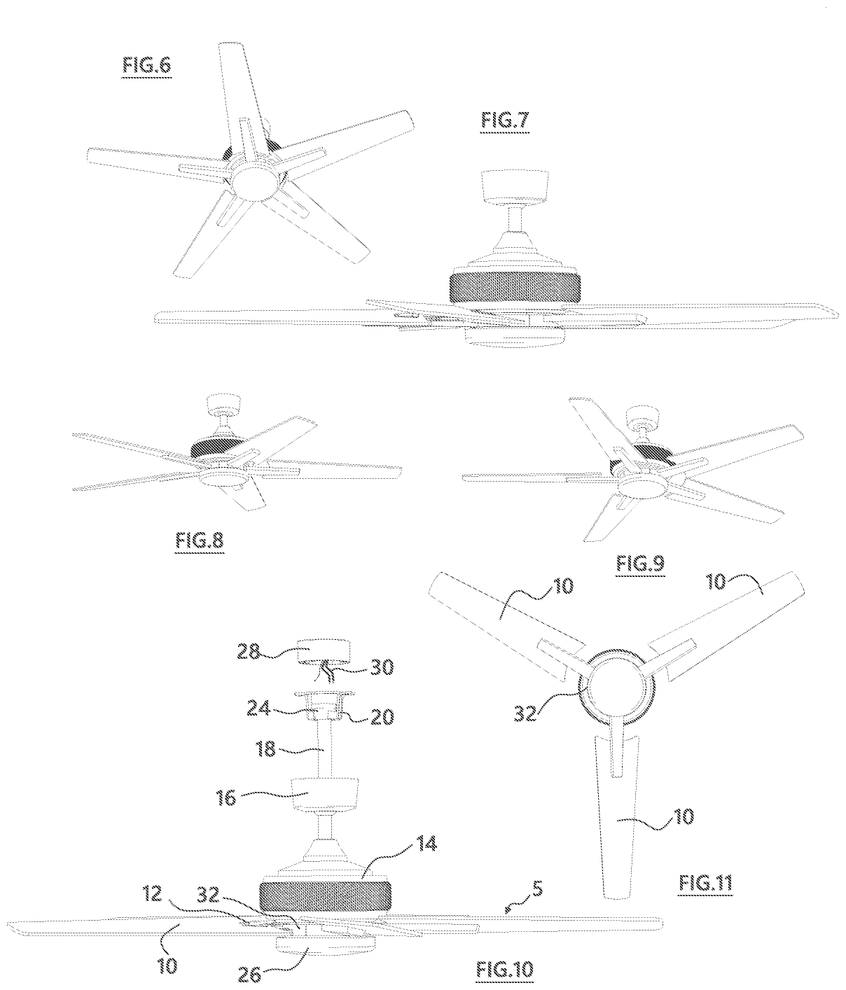

FIGS. 7-11 depict a preferred embodiment electric ceiling fan 5 having an electric motor 14 mounted at the center of the fan with a plurality of blades 10 that extend radially outward from the rotating center hub 32 of the motor 14. The ceiling fan 5 is suspended from a ceiling via a down rod 18 passing through a canopy 16. The canopy 16 covers a mounting bracket 20 attached to the junction box or ceiling fan box 28. At the distal end of the down rod 18 is a hanger ball 24 that suspends the weight of the ceiling fan 5 from inside the mounting bracket 20. The ceiling fan box 28 is preferably screwed or bolted into a ceiling joist. House wires 30 pass from the fan box 28 through the hollow down rod 18 to power the motor 14. At the bottom of the ceiling fan 5 is an optional light fixture 26 to illuminate the room below.

The present invention is directed to an electric ceiling fan and kit where the fan blades may be adjusted by the end user or installer at the installation site. One blade adjustment contemplates extending/shortening the length of each blade by use of different blade irons or physical changes made to the blade iron.

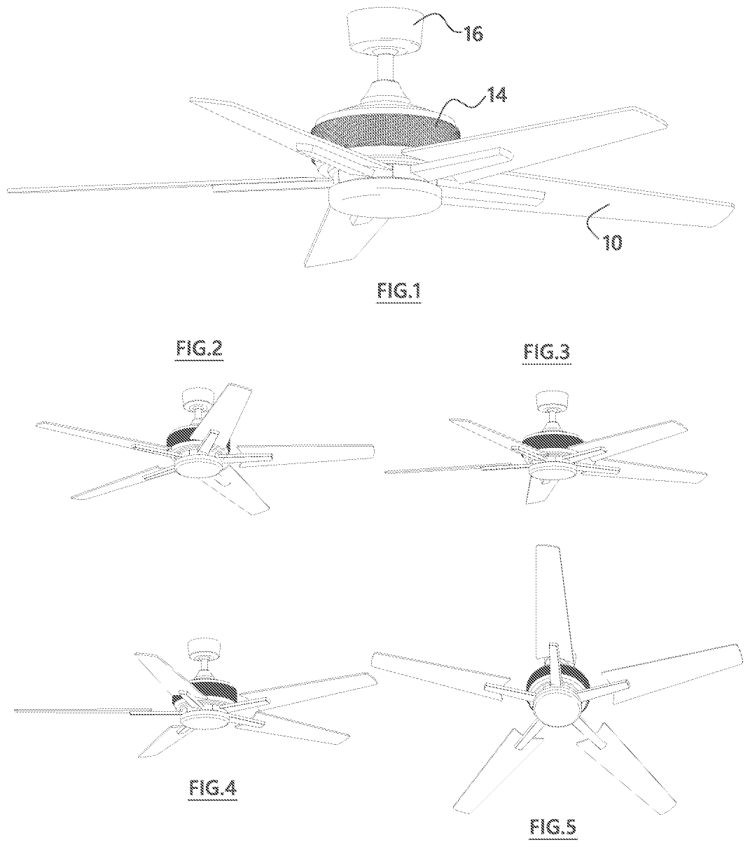

FIG. 11 depicts three blades 10 extending from the motor hub 32 of a ceiling fan. The blade sweep is defined as the diameter of a hypothetical circle delineated by the distal tips of the spinning fan blades. FIGS. 1-5 shows a preferred embodiment ceiling fan with a larger blade sweep diameter. In contrast, FIG. 6 shows the same ceiling fan as in FIGS. 1-5, but with the blade sweep adjusted to a smaller diameter. In this embodiment, the same fan blades are attached to the blade iron arms at different locations thereon to be either farther away from the center hub (larger sweep diameter, FIGS. 1-5, 7-11) or closer to the center hub (smaller sweep diameter, FIG. 6). In alternative embodiments, there may be more than two hole mounting locations along the blade iron to give the user even more choices for setting blade sweep diameter.

Another blade adjustment contemplates setting the pitch angle (as with a propeller in an airplane) of the fan blade by use of different blade irons or making physical changes to the blade irons as discussed in detail below. One or both adjustments enable the user to precisely control the volume, speed, and momentum of the air flow being pushed through the fan blades. Thus, a single fan kit purchased by the end user can be installed to cool a variety of room sizes from small to large merely by setting the proper blade sweep and/or pitch angle.

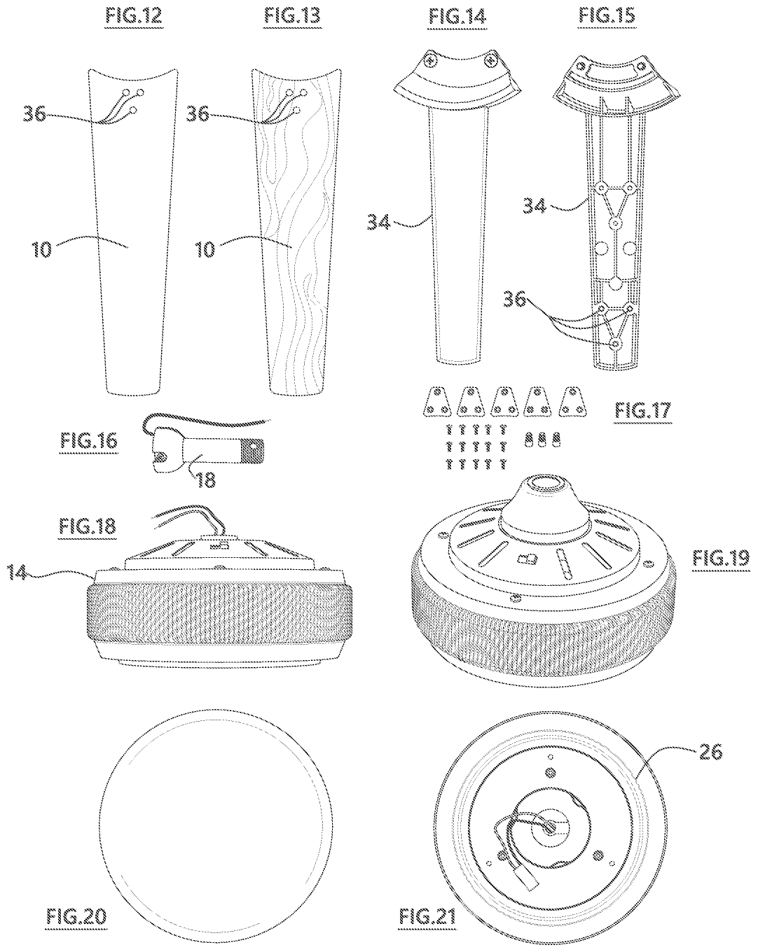

To achieve the sweep adjustments for the fan blades demonstrated in FIGS. 1-11, a preferred embodiment of the present invention is provided with unique fan blades and complementary blade iron mounting arms/blade irons. More precisely, FIGS. 12, 13 show the front and reverse sides of a preferred embodiment fan blade 10. FIGS. 14, 15 show the front and reverse sides of a preferred embodiment blade mounting arm/blade iron 34. At the proximal end of the blades 10 are mounting holes 36 (FIGS. 12, 13), and the blade irons 34 have preferably two sets of three mounting holes 36, with one set located closer to the hub and another set located farther away (FIG. 15). In alternative embodiments, there may be more than or fewer than two mounting hole locations in the blade iron.

Which sets of holes 36 in the blade iron 34 (FIG. 17) selected and used to attach the fan blade 10 sets the blade sweep diameter. Each fan blade 10 is attached to its respective blade iron 34 by aligning the respective mounting holes 36, then passing a fastener or pin and locking the two parts together with mounting brackets and hardware shown in FIG. 17. The multiple locations of the mounting holes 36 are preferably created in the blade irons 36 instead of the fan blade 10, because too much drilling and missing material weakens the already thin and lightweight blades, whereas the blade irons are usually made of metal and have sufficient strength to accommodate multiple mounting holes drilled therein. However, it is still contemplated to form multiple locations for the mounting hole in a fan blade to adjust its sweep.

The preferred embodiment trapezoidal-shaped hardware shown in FIG. 17 that assemble to the blade iron 34 of FIG. 15 are screwed or bolted together using fasteners. Or the parts may clamp together where the trapezoidal-shaped hardware acts as a jaw to clamp onto the proximal end of the fan blade. All of the blade mounting hardware are removable to enable disassembly of the fan blade 10 from the blade iron 34. This allows the user to change the mounting hole attachment location 36 on the blade iron 34 if the blade sweep diameter is determined after installation to be too small or too large, i.e., from the configuration in FIGS. 1-5 to the configuration in FIG. 6 or vice versa.

Each preferred embodiment blade is made from molded or extruded plastic, but aluminum, wood, epoxy, fiberglass or like materials are contemplated. The blades unitary, do not telescope, have a solid core for rigidity. The blades may further have a flat profile (as seen in FIG. 7 or 10), but a curved or airfoil, propeller and the like profiles are also contemplated. Optionally, the obverse and reverse sides (FIGS. 12, 13) may have different finishes or colors which the end user can choose for the visible side facing the room below. These aspects of the blade construction and base material ensure the manufacturing costs are under low, because multiple sets of different length blades may be supplied in a single kit from which the end user may choose the desired length.

FIG. 16 shows a down rod having a tube shape with a hollow interior allowing electrical wires from the house power lines passing through it to the motor 14. FIG. 18 is an isolated view of the electric motor 14. FIG. 19 shows the decorative top cover for the motor assembly. FIG. 20 shows the light fixture lens or diffuser, and FIG. 21 shows the internals of the light fixture 26 covered by the lens or diffuser.

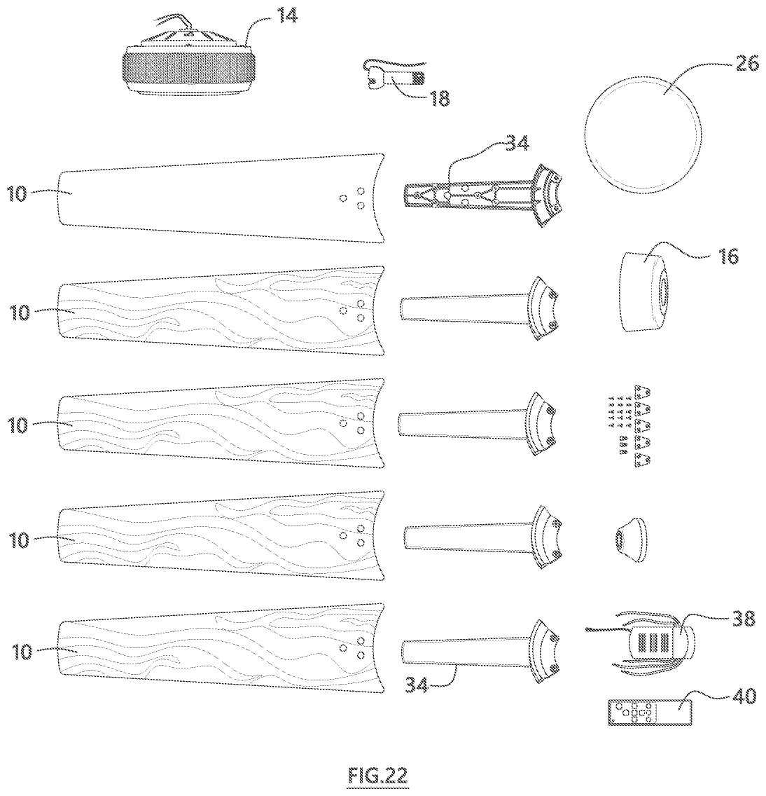

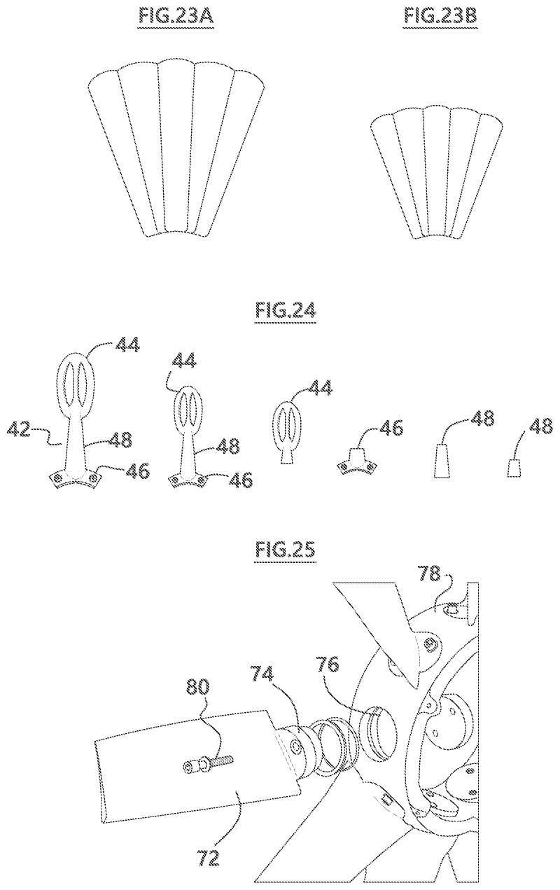

FIG. 22 shows the typical contents of a ceiling fan kit. In this kit, the motor, ceiling mount hardware, fan blade irons, fan blades, light fixture, fan remote controls, etc., are included. The blade sweep can be set when the present invention kit is supplied with different length blades as seen in FIGS. 23A, 23B, or different length blade irons as seen in FIG. 22. The kit components of FIG. 22 may include a Color Coordinated Temperature (CCT) module 38 used to electronically set the color of the LEDs emitting light from the light fixture 26. The components may also include a wireless remote control 40 for controlling fan functions, CCT temperature, motor forward or reverse, power on/off, etc. As seen in FIG. 22, the blades 10 may have different finishes, textures, or colors on either face.

In addition to what was described above, the following drawing figures illustrate more of the contemplated means for adjusting the blade irons/fan blades to set the blade sweep diameter. FIG. 24 shows a blade iron 42 having a distal end 44 (attachable to the proximal end of a fan blade) and a proximal end 46 (attachable to the motor hub). In between the distal end 44 and the proximal end 46 are intermediate sections 48 that are stackable to increase or decrease the overall length of the blade iron 42. By use of more or fewer intermediate sections 48, the blade iron becomes longer or shorter, respectively. Thus, it is possible to adjust the sweep diameter of the blades to increase or decrease. The stackable intermediate sections 48 can be linked together by interference or press fit, mechanical hooks, interlocking joints, an interlocking roll pin, fasteners, adhesive, threaded complementary ends, snap fittings, internal threads, or the like. FIG. 30 shows intermediate sections 50, 52 that are threaded together to extend or shorten the length of a blade iron.

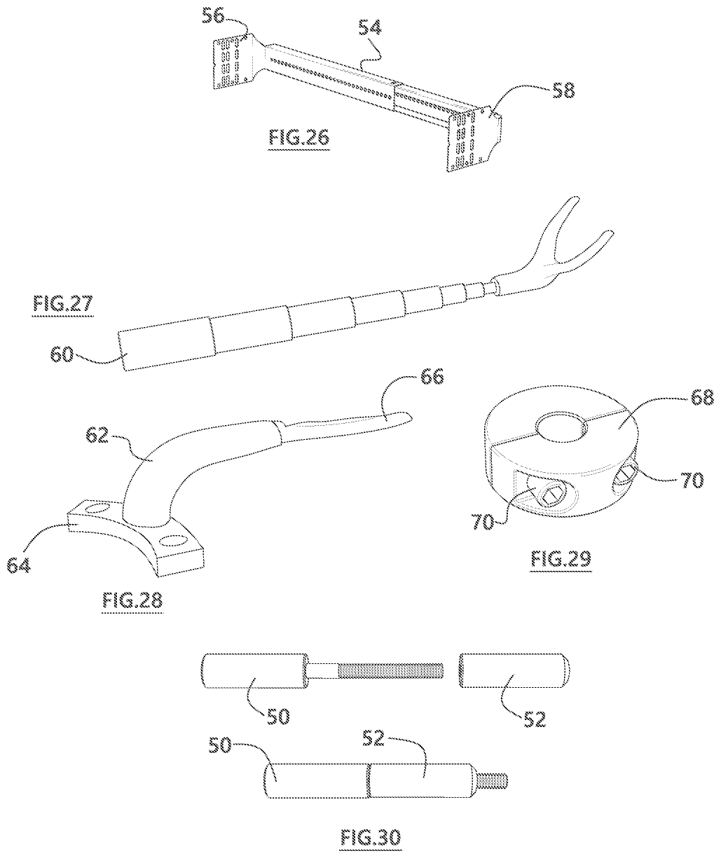

FIG. 26 is an alternative embodiment blade iron 54 using a sliding, telescoping bracket concept for adjusting its length. The blade iron 54 has a distal end 56 attachable to the fan blade and a proximal end 58 attachable to the motor hub with an extended length intermediate section therebetween. The rectangular cross-section of the blade iron allows one section to slide into the other section with a telescoping action. Once that length is set, a roll pin, a stop, a fastener, a catch, a biased hook, a detent, or the like, can be interposed between the two sections to immobilize any relative movement.

FIG. 27 shows an alternative embodiment blade iron 60 that is a single, round shaft that can be simply cut into a shorter overall length, or cut into two pieces by the fan installer, separating the proximal motor end from the distal fan blade end. One or more threaded inserts are then used to re-join the two pieces to form the desired end length for the blade iron.

A tubular shaped blade iron similar to FIGS. 26, 27 may be configured to have a telescoping feature where the intermediate sections retract into the next larger diameter section. The overall blade iron length may be set by retracting and extending the intermediate sections, then twisting on the internally-threaded sections to lock one section to the other.

FIG. 28 depicts yet another alternative embodiment for a blade iron 62 that is formed from a single shaft that can be cut into two pieces by the fan installer, separating the proximal, motor end 64 from the fan blade distal end 66. One or more threaded inserts are then used to re-join the two pieces to form desired lengths for the blade iron. In still another alternative embodiment, short pre-scored segments of the distal end may be broken off by hand into shorter sections. Of course, this would permanently decrease the length of the blade iron. The mounting holes for the distal end to attach the fan blade are repeated for each section that may be broken off.

FIGS. 25 and 29 depict an alternative embodiment blade adjustment means that adjusts the angular pitch of the fan blade. The pitch of the fan blade is the angle at which the blade is oriented relative to the plane defined by the blade's overall rotation around the hub. Thus, in FIG. 29, the fan hub 78 includes lockable collars 70 wherein the collar has a mounting hole 76 receiving the proximal end of a blade iron plug 74 and clamps or locks down on it via fastener 80. Accordingly, the pitch of the fan blade can be set based on the angle of the fan blade when it is locked in place.

In the embodiment of FIG. 25, the blade iron 72 has a plug insert 74 at its proximal end that is inserted into a receiving hole 76 in the motor hub 78. The hub 78 may have reference lines or hash marks to help the fan installer set the desired pitch angle for the blades. A set screw 80 may be threaded into the plug insert 74 to lock the blade iron 72 to the hub 78. Hash marks or markings may be provided on the hub to help guide the installer in setting the fan blade pitch.

In still another alternative for the means for adjusting the blade pitch, the FIG. 28 blade iron may be made from a softer, deformable metal such as aluminum or low carbon steel. Thus, once the length is set, the fan installer may twist and permanently deform the distal, fan blade end 66 of the blade iron relative to the proximal, motor hub end 64. The twisted deformation sets the angular pitch of the fan blade attached to the blade iron.

In the FIG. 27 embodiment, the telescoping blade iron 60 has a length set by twisting the threaded sections together. By that same mechanism, it is possible to twist the interlocking sections to set the angular pitch of the blade.

While the particular forms of the invention have been illustrated and described, it will be apparent that various modifications can be made without departing from the spirit and scope of the invention. It is contemplated that elements from one embodiment may be combined or substituted with elements from another embodiment.

1. An electric ceiling fan with adjustable blades kit, comprising:
a down rod;
a canopy receiving the down rod;
a motor disposed proximate the canopy, wherein the motor includes a rotating hub;
a plurality of low profile, non-telescoping fan blades each having a proximal end and a distal end;
a plurality of low-profile blade irons disposed on the hub, wherein each blade iron further comprises a blade adjustment mechanism selected from the group consisting of:
an arm having a length with different attachment points along the length connecting fan blade attachment points in the proximal end of the fan blade to the blade iron wherein the arm covers the fan blade attachment points;
a plurality of arms having different lengths each connectable to the proximal end of the fan blade to the blade iron;
an arm with jaws that clamp the proximal end of the fan blade; or
an arm with discrete, coaxially stackable segments that connect to the proximal end of the fan blade; and
a power supply conducting electricity to the motor.

2. The electric ceiling fan with adjustable blades kit of claim 1, wherein the blade adjustment mechanism further includes a means for setting an angular pitch of the blade.

3. The electric ceiling fan with adjustable blades kit of claim 1, wherein the ceiling fan includes a light fixture disposed thereon.

4. The electric ceiling fan with adjustable blades kit of claim 1, wherein the electric ceiling fan with adjustable blades kit includes fan blades of different lengths.

5. The electric ceiling fan with adjustable blades kit of claim 1, wherein the kit includes a plurality of blade iron sizes with different length arms.

6. The electric ceiling fan with adjustable blades kit of claim 1, wherein the fan blades include a solid core.

7. The electric ceiling fan with adjustable blades kit of claim 1, wherein opposed surfaces of each fan blade have a different finish.

8. The electric ceiling fan with adjustable blades kit of claim 1, wherein opposed surfaces of each fan blade have a different color.

9. The electric ceiling fan with adjustable blades kit of claim 1, wherein the fan blades include a flat profile.

10. An electric ceiling fan with adjustable blades, comprising:
a down rod;
a canopy receiving the down rod;
a motor disposed proximate the canopy and engaging the down rod, wherein the motor includes a hub;
a blade iron having a first end and second end, wherein the blade iron is attached to the motor hub at the first end, and the second end includes a means for adjusting blade sweep;
a fan blade having non-telescoping, multiple user-selectable lengths with a flat profile including a proximal end and a distal end, wherein the proximal end engages the means for adjusting blade sweep; and
a power supply conducting electricity to the motor.

11. The electric ceiling fan of claim 10, wherein means for adjusting blade sweep further comprises a rotational adjustment for setting a pitch of the blade.

12. The electric ceiling fan of claim 10, wherein the fan includes a light housing.

13. The electric ceiling fan of claim 10, wherein the down rod is attached to a junction box, and the junction box supplies power to the ceiling fan.

14. The electric ceiling fan of claim 10, wherein the means for adjusting blade sweep includes an arm having a length with different attachment points along the length connected to the proximal end of the fan blade.

15. The electric ceiling fan of claim 10, wherein blade iron includes a deformable metal.

16. An electric ceiling fan kit, comprising:
a down rod;
a canopy receiving the down rod;
a motor disposed proximate the canopy and engaging the down rod, wherein the motor includes a hub;
a fan blade having a fixed, non-telescoping length with a flat profile including a proximal end and a distal end;
a blade iron having a first end and second end, wherein the blade iron is attached to the motor hub at the first end, and the second end includes an arm engaging the proximal end of the fan blade that adjusts at least one of the fan blade's sweep and pitch, and wherein the arm includes at least one of:
an arm length with different attachment points along the length connected to fan blade attachment points at the proximal end of the fan blade and the arm covers the fan blade attachment points;
different lengths each connectable to the proximal end of the fan blade;
jaws that clamp the proximal end of the fan blade; and
discrete segments stackable together and connected to the proximal end of the fan blade; and
angular attachment points connected to the proximal end of the fan blade to set a pitch of thereof; and
a power supply conducting electricity to the motor.

17. The electric ceiling fan kit of claim 16, wherein the electric ceiling fan kit includes fan blades of different lengths.

18. The electric ceiling fan kit of claim 16, wherein the electric ceiling fan kit includes fan blades of opposed surfaces having different finishes.

19. The electric ceiling fan kit of claim 16, wherein the kit includes a plurality of blade irons with different arm lengths.

20. The electric ceiling fan kit of claim 16, wherein the electric ceiling fan kit includes a light fixture.

21. An electric ceiling fan with adjustable blades kit, comprising:
a down rod;
a canopy receiving the down rod;
a motor disposed proximate the canopy, wherein the motor includes a rotating hub;
a plurality of low profile, non-telescoping fan blades each having a proximal end and a distal end, wherein the fan blades include at least two different lengths;
a plurality of blade irons disposed on the hub, wherein each blade iron is mechanically attachable to and detachable from the proximal end of the fan blade; and
a power supply conducting electricity to the motor.
